(19) United States
(12) Patent Application Publication
(10) Pub. No.: US 2006/0020908 A1
(43) Pub. Date: Jan. 26, 2006

(54) Unified Approach to Building Web Applications that can be deployed as stand-alone and in Web Portals

(75) Inventors: Pramod Jain, Jacksonville, FL (US); Yayati S Kasralikar, Jacksonville, FL (US); Satya Komatineni, Jacksonville, FL (US); Hoai Nguyen, Jacksonville, FL (US)

Correspondence Address: PRAMOD JAIN, 9000 CYPRESS GREEN DRIVE, 108, JACKSONVILLE, FL, 32256, US

(73) Assignee: INNOVATIVE DECISION TECHNOLOGIES, INC., Jacksonville, FL (US)

(21) Appl. No.: 10/710,576

(22) Filed: Jul. 21, 2004

(51) Int. Cl. G06F 9/44

(52) U.S. Cl. 717/101

(57) ABSTRACT

Disclosed is a method, system and program for creating web applications that can be deployed as standalone or in a web portal with no changes to the server side pages and no changes to backend business components. This method consists of two aspects: method for developing server side pages that enables presentation logic and associated data retrieval logic to be written only once, and a broker class that enables the backend business components to be written only once. Another aspect of the present invention is a single action class for portlet applications that connects the portlet container to backend business components that use data sources, applications and web services.

### BACKGROUND OF INVENTION

1. Field of the Invention

The field of invention is related to the development and deployment of component based web applications and in particular to the deployment of these web applications as standalone applications as well as aggregating them in a portal environment.

2. Description of the Related Art

Java Portlet Specification (JSR) 168 has been developed using Java Community Process (JCP) to enable interoperability between Portlets and Portals. JSR 168 specification defines a set of APIs for Portal computing, addressing the areas of aggregation, personalization, presentation and security.

According to JSR168, A portal is a web based application that—commonly—provides personalization, single sign on, content aggregation from different sources and hosts the presentation layer of Information Systems. Aggregation is the action of integrating content from different sources within a web page. A portal may have sophisticated personalization features to provide customized content to users. Portal pages may have different set of portlets creating content for different users.

A portlet is a Java technology based web component, managed by a portlet container, that processes requests and generates dynamic content. Portlets are used by portals as pluggable user interface components that provide a presentation layer to Information Systems.

A portlet container runs portlets and provides them with the required runtime environment. A portlet container contains portlets and manages their lifecycle. It also provides persistent storage for portlet preferences. A portlet container receives requests from the portal to execute requests on the portlets hosted by it.

Java Server Pages (JSP) is a server side page technology and one of the popular methods to develop portlets.

The process of submitting a request from web application in a web portal and finally delivering a portal page is described in FIG. 1. This method requires creation of server-side action classes and creation of server side pages in JSP.

In the traditional method of developing JSP portlets (see FIG. 1), developers write action classes and methods that are request specific. For example if Portlet 1 has 5 JSPs and each has 2 different submits, then in a worst-case scenario a developer would write 10 methods in Portlet 1's action class. In the Figure these are represented as P1A1 to P1Ai. In the traditional method, action classes are portlet specific. Extending this analysis to four Portlets and each requiring 10 methods would suggest that a developer would write 40 methods. In the FIG. 1 this is represented as P1A1 to P1Ai and PnA1 to PnAm.

The issue with this approach is that for any reasonable size web portal the collection of action classes and methods proliferates and becomes unmanageable. In a project involving a team of developers, this becomes a problem because each team member has a different style of coding, different methods of retrieving data and different methods of packaging data for delivery to JSP.

In addition, these action classes are specific to portlets and cannot be used for standalone deployment. The action classes use portlet specific objects to access session data, portlet request data and create portlet response data.

JSP pages for a portlet have the following constructs: Import various portlet packages; submit button is named eventSubmit_NameOfActionMethod, where NameOfActionMethod is the name of method in the action class of the portlet that will process this submit request; jspeid is stored as a hidden variable; all the dynamic data is retrieved from rundata object. Rundata is an aggregate object that contains the session, Portlet request and Portlet response objects. See FIG. 2 for details. Such JSP pages are not portable to non-portal web applications, because portal specific entities are contained in the JSP.

In summary, in the current art, JSP applications developed for deployment in web portals cannot be reused and deployed as standalone applications, and portlet applications require extensive programming to create portlet specific action classes.

### SUMMARY OF INVENTION

An object of the present invention is to describe a method to create web applications that can be deployed both as standalone applications and as portlets inside web portals. This method consists of two aspects: method for developing server side pages that enables presentation logic and associated data retrieval logic to be written only once, and a broker class that enables the backend business logic to be written only once.

The method for developing server side pages is embodied in a template JSP. The template JSP separates out the three main components: data retrieval, presentation and submit.

1. The data retrieval component delivers a hierarchical data set that is used by the presentation components of the JSP. It is specific to standalone or portlets.

2. The presentation component uses the hierarchical data set to populate data into the user interface of the JSP. This is common to both standalone and portlets.

3. The submit component specifies the method of submitting to standalone server or portal server.

The broker class provides a unified method for both portal and standalone applications to run business components that access backend database, applications and web services.

Another object of the present invention is a single action class for portlet applications that connects the portlet container to backend business components that use data sources, applications and web services.

The benefit of the invention is the effort required for converting a portlet to standalone web application or vice-versa is eliminated. Current web applications developed for portals require extensive changes to the server side pages and server side business components when converting to standalone applications, and vice-versa. In the current invention, both aspects of web application-server side pages and business components-do not have to be changed.

The benefit of the single action class is it reduces the amount of programming required to write backend business components that access databases, applications and web services.

### BRIEF DESCRIPTION OF DRAWINGS

FIG. 1 illustrates the process of submitting one of the applications in portlet to the return of the web portal page with all applications aggregated, according to prior art.

FIG. 2 shows an example, according to the prior art, of server side presentation logic using JSP.

FIG. 3 describes a process flowchart for developing and deploying a web application in accordance with a preferred embodiment of the present invention.

FIG. 4 describes the architecture of system implementing invented process in accordance with a preferred embodiment of the present invention.

FIG. 5 describes the architecture of the data flow to the browser of data that is generated by performing some business logic, in accordance with a preferred embodiment of the present invention.

FIG. 6 Shows the sequence diagram describing the sequence of events in the case of portlet application in accordance with a preferred embodiment of the present invention.

FIG. 7 Shows the sequence diagram describing the sequence of events in the case of standalone web application in accordance with a preferred embodiment of the present invention.

FIG. 8 shows the class diagram in accordance with a preferred embodiment of the present invention.

FIG. 9 shows the flow chart of the server side presentation logic in accordance with a preferred embodiment of the present invention.

FIG. 10 lists code segment for Broker class in accordance with a preferred embodiment of the present invention.

FIG. 11 lists code segment for ActionClass in accordance with a preferred embodiment of the present invention.

FIG. 12 lists code segment for Model class and SQLModel class in accordance with a preferred embodiment of the present invention.

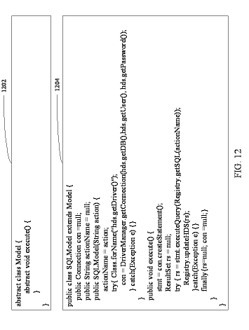

### DETAILED DESCRIPTION

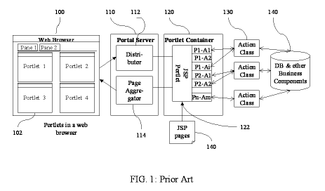

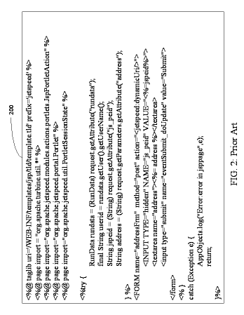

The process of submitting one of the applications in portlet and the return of the web portal page with all applications aggregated, according to prior art, is illustrated in FIG. 1. The backend processing is done by portlet specific Action classes (130), which contain methods for processing individual requests from the portlet. If there are “n” number of portlets (102) in the complete web portal application, then there may be “n” Action classes, and each Action class will have several methods. So the process of creating a new portlet application, according to the prior art, involves creation of an Action class with several methods. An example of server side page using JSP, according to the prior art, is shown in FIG. 2.

Rundata object contains portlet request, response object and portlet session object, and methods to manipulate them. Rundata contains all the data from the server that is then displayed on the page according to presentation logic. Submit action in portlets requires the name of submit button to start with eventSubmit_and doUpdate is the method in the action class that will process this request.

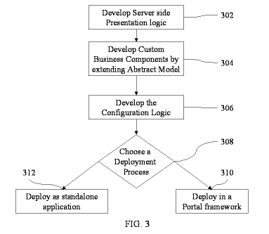

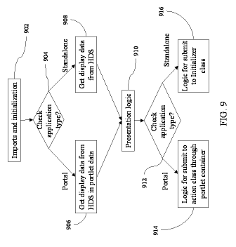

A process flowchart for developing and deploying a web application in accordance with a preferred embodiment of the present invention is shown in FIG. 3. A developer develops server side pages using technology like JSP by following certain guidelines as (302). These guidelines and steps of creating the server side presentation are described in detail in FIG. 9. The server side pages contain a conditional logic (308) for dynamically finding where the application is deployed as a portlet or as a standalone application. Developer develops custom business components (304) and configuration logic (306). The developer can choose to deploy it as a standalone application or in a portal environment without any changes to the application. As the high level process in FIG. 3 illustrates, the server side pages and business components in both types of deployment (portal and standalone) are the same.

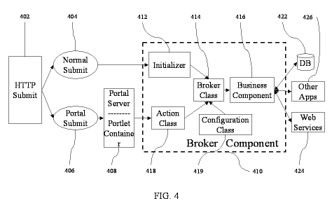

The architecture of system implementing invented process in accordance with a preferred embodiment of the present invention is shown in FIG. 4. The broker component contains Initializer, Action class, Broker class, Configuration class and Business components. The HTTP submit request (402), can be either a normal submit in the case of a standalone application or a portal submit in the case of portal application. A normal submit means that the request directly goes to the web/application server and a portal submit means that the request goes to the portal server. If the HTTP request is a normal submit (404), Initializer object (412) initializes the parameters from the URL. If the HTTP request is a portal submit request (406), the request goes through the portal server and portal container (408) and calls Action class object (418). Action class object initializes the parameters by extracting relevant data from the portlet container. Both Initializer and the Action class call Broker class passing appropriate action types and required data as hds. The Broker class (414) uses the Initializer in the case of standalone application deployment and Action class in case of portal application deployment; reads the configuration object and calls appropriate Business components (416) using the mapping of action types to the Business components as specified in the configuration object (419). The custom Business components that are written for specific actions can call other web services (424) or other applications (426) or perform database actions (422).

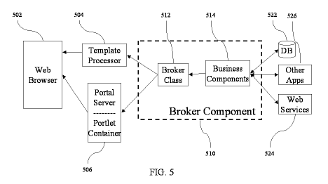

The architecture of the data flow to the browser of the data that is generated by Business components, in accordance with a preferred embodiment of the present invention, is shown in FIG. 5. Broker class (512) receives data from the business components (514), which gets the data from one or more sources (522, 524, 526). The Broker class uses this data and a JSP template to call the template processor (504) if application is deployed as standalone. The template processor generates the HTML, which is displayed in the client's browser (502). If the application is deployed as a portal application, the Broker class calls the portlet container (506), which generates the HTML using the JSP template. HTML pages from other portlets are assembled by the portal server and displayed in the client's browser.

Note in both FIGS. 4 and 5, common server side (JSP) template and common business components are used for standalone and portlet deployment. This enables applications developed in the described method to be deployed in both standalone and portlet environments.

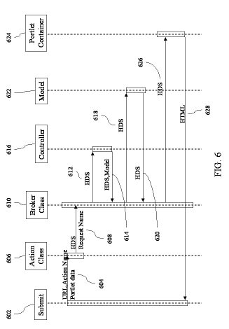

The sequence of events in the case of portlet application deployment in accordance with a preferred embodiment of the present invention is shown in FIG. 6. When the user of the portal application submits (602) an action, Action class (606) is called by the portal container. Submit passes URL, action namee to the Action class. Action class has access to the portlet data (604). The Action class sets the initial parameters into HDS object and calls the Broker class (610). HDS stands for Hierarchical Data Sets and is a popular programming construct for accessing and storing data in the memory. There are different ways to implement HDS. The Broker class passes the action name to the Controller using HDS (612). Controller puts the type of the Model and other parameter into HDS and creates the Model. It passes them back to the Broker (614). Depending on the type of the Model, Broker class creates specific model object at runtime and calls the execute method on the Model. Model (622) uses data in HDS (618), executes the business logic, fills the HDS with generated output data and returns it back to the Broker class (620). Broker class finally calls the portlet container and passes HDS to it (626). Portlet container (624) uses the server side template and the HDS and generates the HTML (628).

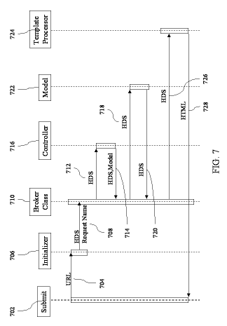

The sequence of events in the case of standalone application deployment in accordance with a preferred embodiment of the present invention is shown in FIG. 7. When the user of the standalone application submits (702) an action, Initializer (706) is called. Submit passes URL to the Initializer, which sets the initial parameters into HDS object and calls the Broker class (710). Rest of the steps in the sequence diagram in the case of standalone application deployment are similar to the steps described before for portlet application deployment with one difference that Broker class instead of calling a portlet container to generate HTML calls the template processor (724) of the servlet container to generate the HTML.

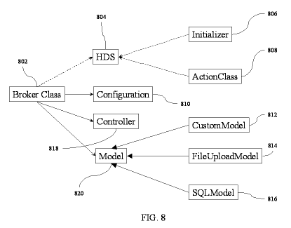

The class diagram, in accordance with a preferred embodiment of the present invention, is shown in FIG. 8. HDS (804), contains initialization data as well as data generated from the Business Components. Initializer class (806) is used for standalone web application deployment. It interprets the URL string and initializes the HDS. Action class (808) is used in case of portal application deployment. It interprets the URL string and portlet specific data and initializes the HDS. Configuration class (810) stores all configuration data such as mapping of action name and model type, and of model type and business component. Broker class (802) uses HDS and configuration object and calls the Controller. It provides an interface for other objects. Controller class (818) interprets the configuration object and calls the appropriate model through Broker class. Model class (820) is an abstract class and at runtime Broker calls appropriate business component. Custom Business components must extend the Model class. CustomModel, SQLModel and FileUploadModel are business components developed by extending Model class. Broker class has an association relationship with Controller, Model and Configuration classes. It is shown by solid arrow. It means Broker class has Controller, Model and Configuration classes. Broker class, Initializer class and ActionClass use HDS class to pass the data around. This relationship is a dependency relationship and is shown by dashed arrow. CustomModel, FileUploadModel and SQLModel inherit the Model by extending it. This relationship is shown by an arrow with a solid arrowhead.

The flow chart of the server side page, in accordance with a preferred embodiment of the present invention, is shown in FIG. 9. The developer uses the logic described in the flowchart to develop server side page. In the code, after the imports and initialization (902), the developer writes a conditional check (904) to see if the web application is deployed as a standalone application or as a portal application. If it is deployed as a portal application, then it gets the initial parameter from the portlet data using the Action class (906). If it is deployed as a standalone application, then it gets the initial parameter from the URL using the Initializer class (908). It then executes common presentation logic (910). Next the submit logic in the server side page (912) is determined by type of deployment.

The broker class (described in FIG. 8) and the server side pages (described in FIG. 9) enable a web application to be deployed both as a portlet and as standalone.

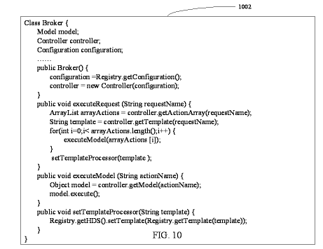

Code segment for Broker class, in accordance with a preferred embodiment of the present invention, is shown in FIG. 10. Broker Class (1002) has Model, Controller and Configuration objects. While getting constructed, it gets the Configuration object from the Registry. The Registry is a popular storage facility for storing and accessing information about applications. Using this configuration object, a controller object is created. Either the ActionClass or the Initializer object calls the executeRequest method of the Broker class passing the request name. The Broker class asks the controller to get the array of actions. It then calls the executeModel method for each action, while passing the action name. Controller uses HDS object, which it gets, from Registry and the action name and gives back the customModel. Controller also updates the HDS by putting other parameters necessary for that particular Model object to execute the business logic. The execute method of the customModel which is of different type at runtime depending upon the action name is called. The broker class finally calls setTemplateProcessor method to set the jsp template in the HDS object.

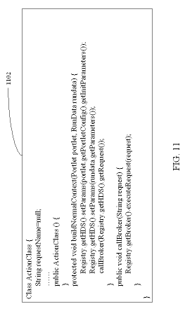

FIG. 11 shows the code listing for the ActionClass. ActionClass (1102) object is called in case of portlet application deployment. The portlet container calls the buildNormalContext method of the ActionClass. In this method, the ActionClass initializes the HDS and puts the portlet specific parameters and the request name intoHDS. It gets the Broker class from the Registry and calls the executeRequest method on the Broker object passing the request name parameter.

The Model class (1202) is an abstract class, which must be extended by the Business component developers to develop custom Business components which are also called custom Models. It has an abstract execute( ) method. The SQLModel (1204) extend the Model class and by implementing execute( ) method. While getting constructed, SQLModel creates a connection object. In execute( ) method, it retrieves the query from the registry for the given action name. It then calls a Registry method to put the data that is returned by the query.

The present invention provides numerous advantages. Generally, the invention reduces the expense and effort of redeploying a web application as a portlet or standalone application. The technique enables the efficient reuse of server side pages and broker class.

In addition, it reduces the expense and effort of developing action classes for portlet applications. The technique enables the efficient reuse of a generic action class and broker class such that business components can be developed without writing any procedural code.

As noted above, the above-described functionality preferably is implemented in software executable in a processor, namely, as a set of instructions (program code) in a code module resident inside an application server.

In addition, although the various methods described are conveniently implemented in a web portal server, one of ordinary skill in the art would also recognize that such methods may be carried out in any software, hardware or firmware that aggregates webpages from multiple web applications.

In addition, although the various methods described are conveniently implemented in a portlet container, one of ordinary skill in the art would also recognize that such methods may be carried out in any software, hardware or firmware that handles requests from a single web application when several web applications are being displayed at the client, and retrieves data from the business component associated with the web application that submitted the request.

Further, as used herein, a Web “client” should be broadly construed to mean any computer or component thereof directly or indirectly connected or connectable in any known or later-developed manner to a computer network, such as the Internet. The term Web “server” should also be broadly construed to mean a computer, computer platform, an adjunct to a computer or platform, or any component thereof. Of course, a “client” should be broadly construed to mean one who requests or gets the file, and “server” is the entity, which downloads the file.

What is claimed is:

1. A method of developing a web application, which can be deployed as is in a JSP168 compliant portal framework as well as deployed as a standalone web application

2. The method as set forth in claim 1, where the server side pages contain data access logic with conditional check that gets data from the portal server or standalone server

3. The method as set forth in claim 2, where in presentation logic in the server side pages is common

4. The method as set forth in claim 2, where the submit logic in the server side pages contains a conditional check that chooses portal server or standalone server to submit

5. The method as set forth in claim 1, where in a single broker class handles all the backend processing for both portal server and standalone

6. The method as set forth in claim 1, where in a single action class connects the portlet container to the broker class in the case of portal application
